(19) United States
(12) Patent Application Publication
(10) Pub. No.: US 2012/0085187 A1
(43) Pub. Date: Apr. 12, 2012

(54) GEARLESS OFFSET STEERING SHAFT COUPLING

(75) Inventor: Stephen F. Burns, Huntertown, IN (US)

(73) Assignee: International Truck Intellectual Property Company, LLC, Warrenville, IL (US)

(21) Appl. No.: 12/902,400

(22) Filed: Oct. 12, 2010

(51) Int. Cl. B62D 3/02; B23P 11/00; F16H 49/00

(52) U.S. Cl. 74/216.3; 29/428

(57) ABSTRACT

A steering shaft coupling device and method providing a gearless, offset steering arrangement. The device includes a housing having an first section and a second section forming a compartment having two adjacent openings therein, a first and a second CV joint, each CV joint seated within each one of the openings of the housing compartment, and a linkage joining the first and second joints. The CV joints may also function as slip joints.

### TECHNICAL FIELD

The present device relates generally to vehicular steering systems. Particularly, the device relates to an gearless offset steering shaft coupling and method for providing an offset steering arrangement.

### BACKGROUND

Numerous strategies have been developed to actuate steering in motor vehicles. Some steering systems include a pair of steering knuckles supported on a chassis for vertical suspension purposes and for movement of wheels about a pair of axes. The wheels are rotatably mounted to the steering knuckles are free to pivot thereby allowing the vehicle to turn. A rack-and-pinion steering system typically includes a rack and pinion steering assembly mounted on the chassis, and a pair of tie rods attaching the steering gear to the steering knuckles. In a non-power assisted rack and pinion steering gear assembly, turning the steering wheel causes the pinion to turn, which directly causes the rack to move. In a hydraulic power assisted rack and pinion steering gear assembly, when the steering wheel is turned a hydraulic valve is actuated and fluid is directed to a hydraulic motor which moves the rack. The pinion is rotated by the rack in a follow-up manner to return the hydraulic valve to neutral as the wheels turn.

An integral gear steering system may include a steering gear operably attached to the chassis and a drag link positioned between the steering gear and the tie rods. The integral gear steering system usually has greater mass than the rack-and-pinion steering system but relatively greater compliance due to dimensional clearances in the pivotal connections between the additional structural elements. The integral gear steering system may be more suitable for motor “heavy-use” vehicles subject to a wide range of loads (e.g., vans, trucks, sport utility vehicles, etc.) than the rack-and-pinion steering system unless complex and expensive structure is provided to account for the reduced compliance of the rack-and-pinion steering system relative to the integral gear steering system. The rack-and-pinion type steering system, however, may be advantageous to other types of steering arrangements (including integral gear steer systems) in that it is relatively lightweight, has a comparatively simple arrangement, provides superior steering performance, and requires a small mounting space.

Placement of the steering gear or rack and pinion assembly on a vehicle is typically determined first by the relationship to the steering axle and second, to the steering column. However, many different vehicle designs have the driver position and steering column located where the steering column shaft cannot reach from the column to the gear without sharp angles or multiple sections of shafts at different angles. The present device is intended to provide options for placement of the steering column in relation to the steering axle, without the sharp angles or multiple sections of steering shaft at different angles found in current steering assembly designs. In addition, the present device does not utilize gears that require meshing, avoiding tolerance and alignment issues and providing smooth steering. Finally, the present device can also function as a slip joint for adjustability of the steering column shaft and steering axle, as needed.

### SUMMARY

Generally speaking, a steering shaft coupling device comprises a housing having an first section and a second section forming a compartment having two adjacent openings therein, a first and a second CV joint, each CV joint seated within each one of the openings of the housing compartment, and a linkage joining the first and second joints.

In one aspect, the first CV joint is an input joint for receiving an input shaft, and the second CV joint is an output joint for receiving an output shaft, providing an offset arrangement for the input shaft and the output shaft.

In another aspect, the linkage comprises a ball bearing drive.

In another aspect, an outer surface of each CV joint includes a circumferential recess for engaging the linkage.

In yet another aspect, the linkage travels within a track formed within the housing compartment, surrounding the openings, and engaging the recesses of the joints providing rotational movement of the CV joints for both the input shaft and the output shaft track.

In yet another aspect, the CV joints include a center profile which functions as a slip joint capable of adjusting the input shaft to a steering column and adjusting the output shaft to a steering axle.

A method of providing a gearless offset steering shaft coupling, wherein the method includes the steps of providing a housing providing a housing having a first section and a second section forming a compartment having at least two adjacent openings therein, providing an input joint and an output joint, seating each joint within each one of the openings, and, providing a linkage surrounding the openings and seated joints, the linkage capable of engaging with and driving each of the input joint and the output joint.

These and other aspects of the device and method may be understood more readily from the following description and the appended drawings.

### BRIEF DESCRIPTION OF THE DRAWINGS

FIG. 1 is a perspective view of the steering shaft coupling device.

FIG. 2 is a perspective view of the steering shaft coupling device with the top cover removed.

FIG. 3 is an exploded view of the steering shaft coupling device.

### DETAILED DESCRIPTION

Referring to FIGS. 1-3, there is illustrated an embodiment of a gearless, offset steering shaft coupling device, generally designated by the numeral 10. The offset design of the device 10 allows the device to be used in a variety of applications including those where space is restricted. The device 10 may be adapted for use to control front steering of a motorized automobile, four-wheeled van, truck, automobile, and sport utility vehicle. Alternatively, the device 10 may control steering of numerous other motorized and non-motorized vehicles including two or more wheels. The offset arrangement of the present device 10 provides options for changing the location of the steering assembly (not shown), depending on the specific requirements of the vehicle.

Generally speaking, the device 10 comprises a housing 12 having a first section 14 and a second section 16 forming a compartment 18 having at least two adjacent openings 20, a first opening 20a and a second opening 20b. Optionally, the first opening 20a may be an input opening, while the second opening 20b is an output opening. However, the arrangement of the first opening 20a and second opening 20b may vary depending on the design and technical specifications of the vehicle. A gasket 22, made from a pliable material such as rubber or plastic, may be positioned between the first section 14 and second section 16, providing for a sealed compartment 18. The housing 12 and other components of the device 10 may be manufactured from materials such as steel, aluminum, metal(s), metal alloy, composites, polymers, and other material known in the art for the manufacture of steering assembly components.

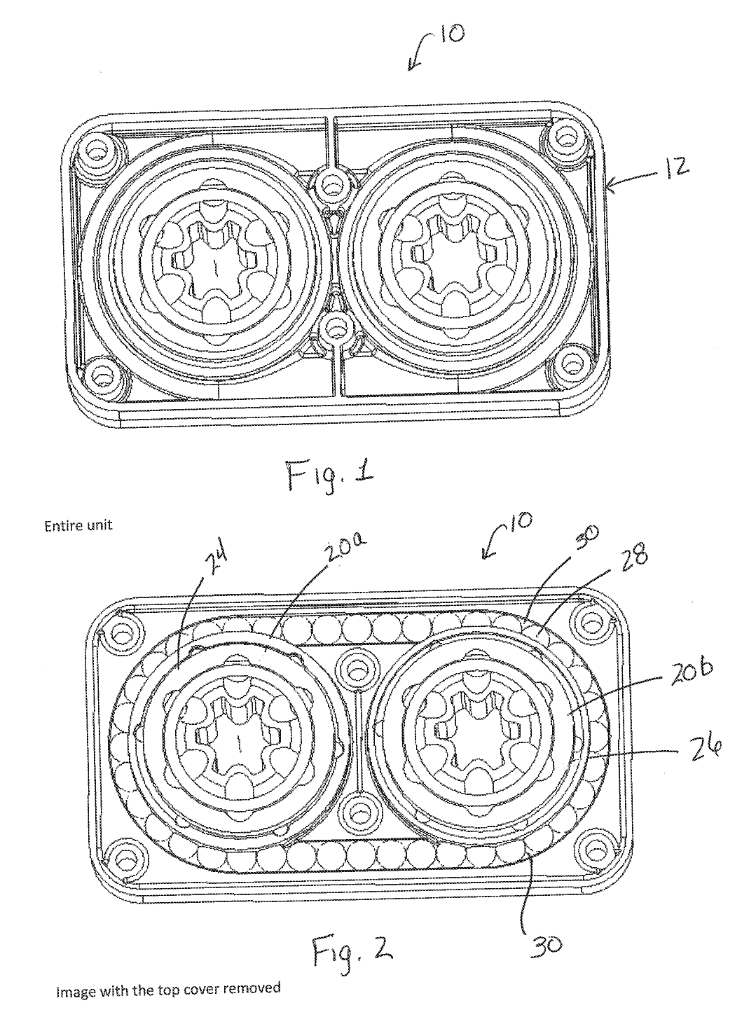

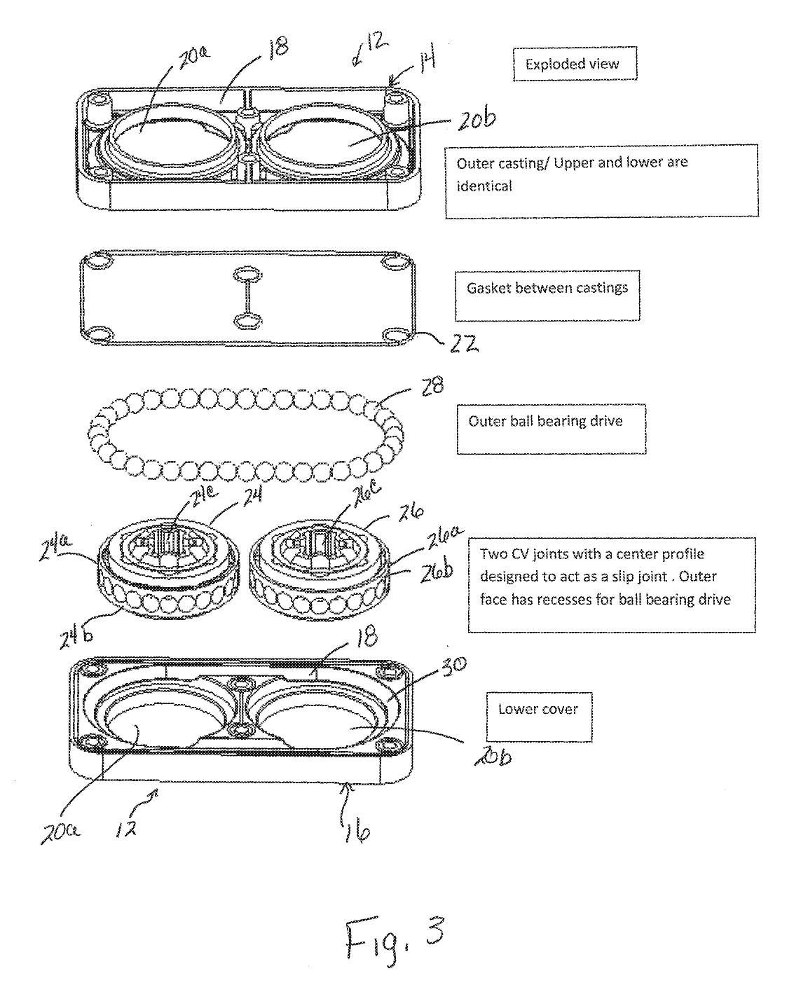

Nearly parallel shafts, such as an input shaft for the steering shaft (not shown) and an output shaft for the steering axle (not shown) may be joined with flexible couplings, which provide a small amount of angular, torsional and longitudinal flexibility to ease alignment difficulties. As shown in FIGS. 2 and 3, the present device 10 includes a first CV joint 24 and a second CV joint 26, each joint to serve as a coupling for the steering components. Universal joints may also be used. Each joint 24, 26 is seated within each one of the openings 20a and 20b of the housing compartment 18. The first joint 24 may receive the input shaft (not shown) for a steering column (not shown), while the second joint 26 receives the output shaft (not shown) for the steering axle (not shown). It is understood that the arrangement of the input shaft and output shaft may change depending on the requirements of a particular vehicle.

The first and second joints 24, 26 are operationally joined together by a linkage 28. The linkage 28 connects and drives the rotational movement of the first joint 24 and second joint 26, thereby operating the steering assembly when the device 10 is placed into a vehicle. The linkage 28 may be a belt, chain or a series of ball bearings, or any other suitable connection. In the present device 10, the linkage 28 is a ball bearing drive, which is not prone to breaking or stretching, thereby maintaining smooth operation of the steering assembly (not shown).

The linkage 28 is positioned within the housing compartment 18 in a track 30. The track 30 may be slightly concave or indented for accommodating the linkage 28. As shown in FIG. 2, the track 30 surrounds both of the openings 20a, 20b containing the seated CV joints 24, 26.

In order to for the linkage 28 to engage and rotate the CV joints 24, 26, the outer surfaces 24a and 26a of each joint includes a circumferential recess 24b, 26b. The linkage 28 is received within the track 30, and also engages the recesses 24b, 26b of each joint 24, 26. While not shown, an input shaft relating to the steering column and an output shaft relating to the steering axle would be positioned in each CV joint 24, 26 respectively. When the linkage 28 is seated within the track 30 and engaged with the recesses 24b, 26b of each joint 24, 26, it functions as a drive for the rotational movement of the first joint 24 to the second joint 26, thereby operating the steering assembly of the vehicle.

In addition to providing rotational movement, each CV joint 24, 26 has a center profile 24c and 26c, respectively, designed to act as a slip joint. Slip joints generally allow extension and compression in a linear structure. In the present device 10, the slip joint action would permit extension and compression movement of the input shaft and the output shaft. A slip joint may be useful for adjusting the steering components. For example, a slip joint may be useful for adjusting the input shaft and thus the steering column length for driver clearance, and adjusting the output shaft and length and route to the steering gear. Additionally, a slip joint may be useful, for example, in a truck where the cab tilts upward and forward for service. In this situation, the steering gear may be at an extreme angle back to the steering column, requiring a very long slip joint to allow the cab to tilt for service. The offset steering device 10 with the joints 24, 26 acting as slip joints would be useful in this application.

In use, the present device 10 provides a gearless offset steering shaft coupling. The input joint 24 and output joint 26 seated within each of the openings 20 of the housing 12 permit an offset arrangement of the input shaft relating to the steering shaft (not shown) and output shaft relating to the steering axle (not shown), respectively. The linkage 28, which may be a ball bearing drive, engages with and drives each of the input joint 24 and the output joint 26, and their respective shafts, thereby permitting smooth steering of the vehicle. In addition, the joints 24, 26 can act as slip joints for adjusting the input shaft and the output shaft. In this manner, the method provides for adjusting the input shaft and thus, the steering shaft and driver clearance, and adjusting the output shaft to the steering axle, all without meshing gears and sharp angles found in typical steering arrangements.

### LIST OF ELEMENTS

10—device
12—housing
14—first section
16—second section
20—openings
20a—first opening
20b—second opening
22—gasket
24—first CV joint
24a—outer surface
24b—recess
24c—center profile
26—second CV joint
26a—outer surface
26b—recess
26c—center profile
28—linkage
30—track

What is claimed is:

1. A steering shaft coupling device comprising:
a housing having an first section and a second section forming a compartment having two adjacent openings therein;
a first and a second CV joint, each CV joint seated within each one of the openings of the housing compartment; and,
a linkage joining the first and second joints.

2. The device of claim 1, wherein the first and second joints are positioned adjacent to one another within the housing compartment.

3. The device of claim 1, wherein the first CV joint is an input joint for receiving an input shaft and the second CV joint is an output joint for receiving an output shaft.

4. The device of claim 2, wherein the CV joints provide an offset arrangement for the input shaft and the output shaft.

5. The device of claim 4, wherein each of the CV joint includes a center profile which functions as a slip joint.

6. The device of claim 5, wherein the slip joint is capable of adjusting the input shaft to a steering column and adjusting the output shaft to a steering axle.

7. The device of claim 1, wherein the linkage comprises a ball bearing drive.

8. The device of claim 7, wherein an outer surface of each CV joint includes a circumferential recess for engaging the ball bearing drive.

9. The device of claim 8, wherein the linkage travels within a track surrounding the openings within the housing compartment and the recess providing rotational movement of the couplings for both the input shaft and the output shaft.

10. A steering shaft coupling device for use in a vehicle, the device comprising;
a housing having a first section and a second section forming a compartment therein;
at least two openings formed adjacent to one another within the housing compartment;
an input joint and an output joint, each joint seated within each of the openings in the housing compartment;
a track formed within the housing compartment and surrounding the openings containing the input joint and the output joint; and
a linkage positioned within the track and capable of engaging and driving each of the input joint and the output joint.

11. The device of claim 10, wherein the joints comprise CV joints.

12. The device of claim 11, wherein each joint includes a circumferential recess.

13. The device of claim 12, wherein the recess engages the linkage.

14. The device of claim 12, wherein the linkage comprises a ball bearing drive.

15. A method of providing a gearless offset steering shaft coupling, the method including the steps of:
providing a housing having a first section and a second section forming a compartment having at least two adjacent openings therein;
providing an input joint and an output joint;
seating each joint within each one of the openings; and,
providing a linkage surrounding the openings and seated joints, the linkage capable of engaging with and driving each of the input joint and the output joint.

15. The method of claim 15, wherein the method further comprises the step of providing a track formed within the housing compartment and surrounding the openings, wherein the track receives the linkage.

16. The method of claim 15, wherein the step of driving the rotational movement of the input joint and output joint further comprises providing a circumferential recess around each joint for engaging the linkage.

17. The method of claim 15, wherein the linkage comprises a ball bearing drive.

18. The method of claim 15, wherein the joints comprise CV joints.

19. The method of claim 15, wherein the joints function as slip joints.

20. The method of claim 15, wherein the method further includes providing an offset arrangement of an input shaft and an output shaft.
